(19) United States
(12) Patent Application Publication
(10) Pub. No.: US 2025/0379396 A1
(43) Pub. Date: Dec. 11, 2025

(54) Power Cord Strain-Relief Device

(71) Applicants: Matthew Putman, Battle Creek, MI (US); Valerie Putman, Battle Creek, MI (US)

(72) Inventors: Matthew Putman, Battle Creek, MI (US); Valerie Putman, Battle Creek, MI (US)

(21) Appl. No.: 18/973,223

(22) Filed: Dec. 9, 2024

Related U.S. Application Data
(60) Provisional application No. 63/658,474, filed on Jun. 11, 2024.

(51) Int. Cl. H01R 13/58; H02G 15/007

(52) U.S. Cl. CPC H01R 13/5804; H01R 13/5837; H02G 15/007

(57) ABSTRACT

A power cord strain relief device is provided, designed to reduce or eliminate strain on power cables connected to RVs, marine vehicles, or similar vehicles. The device comprises a body with a first end that rests against a vehicle bumper and a second end featuring an opening for securing a power cord in a position that reduces or eliminates internal strain within the power cord. During use, a first end of the body rests against the vehicle's bumper. The second end contains an opening formed by two halves connected by a connector, through which a power cord is positioned and secured with a fastener. Additionally, the device includes a receiving area that holds the power cord head securely, utilizing fasteners such as straps or clips to prevent strain on the cord.

### CROSS-REFERENCE TO RELATED APPLICATION

The present application claims priority to, and the benefit of, U.S. Provisional Application No. 63/658,474, which was filed on Jun. 11, 2024, and is incorporated herein by reference in its entirety.

### FIELD OF THE INVENTION

The present invention relates generally to the field of power cords. More specifically, the present invention relates to a power cord strain-relief device designed to reduce or eliminate strain on power cables connected to vehicles by securing the power cord and a power cord head with various fasteners in a position that minimizes internal strain on the cord. Accordingly, the present disclosure makes specific reference thereto. Nonetheless, it is to be appreciated that aspects of the present invention are also equally applicable to other like applications, devices, and methods of manufacture.

### BACKGROUND

Power cord strain is a significant issue faced by RV and boat owners, leading to costly repair bills and posing potential safety hazards. This problem arises when power cords, particularly those that screw on, are not adequately supported, resulting in excessive strain on internal connections within the power cord. Over time, this strain can cause the connections to become damaged, break, or even short out, creating a dangerous situation. Additionally, the strain can lead to excessive heat buildup at the connection points, which poses a severe risk as it can cause the electrical components to melt or, in the worst-case scenario, start a fire.

This issue is compounded by the fact that many RV and boat owners often find themselves in remote locations where access to repair services is limited or non-existent. The inconvenience, coupled with the potential safety risks, makes this a pressing concern for those who rely on their vehicles for travel and leisure. Despite the widespread nature of this problem, there is currently no cost-effective solution available on the market to reduce or eliminate the cable strain placed on screw-on power cords.

Therefore, there exists a long-felt need in the art for a device for preventing strain damage to a power cord. There also exists a long-felt need in the art for a power cord strain-relief device. More specifically, there exists a long-felt need in the art for a power cord strain-relief device that prevents internal strain from occurring to the power cord of an RV, a boat, or other similar vehicle of the like. In addition, there exists a long-felt need in the art for a power cord strain-relief device that prevents internal strain from occurring to the power cord of an RV, a boat, or other similar vehicle of the like wherein the device can be universally used with any power cord size, shape, and configuration.

The subject matter disclosed and claimed herein, in one embodiment thereof, comprises a power cord strain relief device. The device is designed to reduce or eliminate strain on power cables connected to RVs, marine vehicles, or similar vehicles. The device comprises a body with a first end that rests against a vehicle bumper and a second end featuring an opening for securing a power cord in a position that reduces or eliminates internal strain within the power cord. During use, a first end of the body rests against the vehicle's bumper. The second end contains an opening formed by two halves connected by a connector, through which a power cord is positioned and secured with a fastener. Additionally, the device includes a receiving area that holds the power cord head securely, utilizing fasteners such as straps or clips to prevent strain on the cord.

In this manner, the power cord strain relief device of the present invention accomplishes all the forgoing objectives and provides a device that prevents internal strain from occurring to the power cord of an RV, a boat, or other similar vehicle of the like. In addition, the device can be universally used with any power cord size, shape, and configuration. Further, the device secures a power cord in place during use.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a power cord strain relief device designed to reduce and/or remove strain from a power cable that may be connected to an RV, marine vehicle, or other vehicle of the like. The device is comprised of a body, the body comprised of a first end and a second end. The first end of the body is comprised of at least one member that rests against the bumper of an RV (or other surface of other vehicle) when the device is in use.

The second end is comprised of at least one opening. In one embodiment, the opening may be formed by a first half, a second half, and a connector. More specifically, the connector is positioned between the halves. As a result, a power cord can be placed between the halves, wherein the connector can then be inserted between the halves and wherein at least one fastener can be placed through the halves and connector such that the opening is formed and the cord is secured within the same. As a result, the power cord is secured to the device in a position that minimizes internal strain on the power cord.

The device is also comprised of a receiving area that receives a power cord head of a power cord. The receiving area may be any shape such that it can securely receive a power cord head such that a portion of the head rests within and is supported by the receiving area. To further secure the power cord head into the receiving area, the receiving area may be comprised of at least one fastener. As a result, the power cord head remains secured to the device while the positioning of the power cord in the opening reduces or eliminates internal strain within the power cord. The fastener may removably or fixedly attach to any portion of the receiving area.

The present invention is also comprised of a method of using the device. First, a device is provided comprised of a body comprised of a second end comprised of an opening and a receiving area comprised of a fastener. Then, a power cord head of a power cord can be plugged into an RV or other vehicle. Next, the power cord can be positioned within the opening such that the cord and/or cord head does not experience external strain. Next, the power cord head can be positioned within the receiving area and secured within said area via the fastener.

Accordingly, the power cord strain relief device of the present invention is particularly advantageous as it provides a device that prevents internal strain from occurring to the power cord of an RV, a boat, or other similar vehicle of the like. In addition, the device can be universally used with any power cord size, shape, and configuration. Further, the device secures a power cord in place during use. In this manner, the power cord strain relief device provides a solution to preventing power cord internal strain when used with RVs or other vehicles of the like.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one potential embodiment of a power cord strain relief device of the present invention in accordance with the disclosed architecture;

FIG. 2 illustrates a side perspective view of one potential embodiment of a power cord strain relief device of the present invention while attached to a power cord and a power cord head in accordance with the disclosed architecture;

FIG. 3 illustrates a flowchart of a method of using one potential embodiment of a power cord strain relief device of the present invention in accordance with the disclosed architecture; and

FIG. 4 illustrates a flowchart of a method of using one potential embodiment of a power cord strain relief device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for preventing strain damage to a power cord. There also exists a long-felt need in the art for a power cord strain-relief device. More specifically, there exists a long-felt need in the art for a power cord strain-relief device that prevents internal strain from occurring to the power cord of an RV, a boat, or other similar vehicle of the like. In addition, there exists a long-felt need in the art for a power cord strain-relief device that prevents internal strain from occurring to the power cord of an RV, a boat, or other similar vehicle of the like wherein the device can be universally used with any power cord size, shape, and configuration.

The present invention, in one exemplary embodiment, is comprised of a power cord strain relief device. The device is designed to reduce and/or remove strain from a power cable that may be connected to an RV, marine vehicle, or other vehicle of the like. The device is comprised of a body comprised of a first end and a second end. The first end of the body is comprised of at least one member that rests against the bumper of an RV (or other surface of other vehicle) when the device is in use. The second end is comprised of at least one opening. In one embodiment, the opening may be formed by a first half, a second half, and a connector, wherein the connector is positioned between the halves. As a result, a power cord can be placed between the halves, wherein the connector can then be inserted between the halves and wherein at least one fastener can be placed through the halves and connector such that the opening is formed and the cord is secured within the same. As a result, the power cord is secured to the device in a position that minimizes internal strain on the power cord. The RV will have a permanent mounted connector and the power cord will also have a connector. When used properly, the present invention will remove the stress from both.

The device is also comprised of a receiving area that receives a power cord head of a power cord. The receiving area may be any shape such that it can securely receive a power cord head such that a portion of the head rests within and is supported by the receiving area. To further secure the power cord head into the receiving area, the receiving area may be comprised of at least one fastener. As a result, the power cord head remains secured to the device while the positioning of the power cord in the opening reduces or eliminates internal strain within the power cord. The fastener may removably or fixedly attach to any portion of the receiving area.

The present invention is also comprised of a method of using the device. First, a device is provided comprised of a body comprised of a second end comprised of an opening and a receiving area comprised of a fastener. Then, a power cord head of a power cord can be plugged into an RV or other vehicle. Next, the power cord can be positioned within the opening such that the cord and/or cord head does not experience external strain. Next, the power cord head can be positioned within the receiving area and secured within said area via the fastener.

Accordingly, the power cord strain relief device of the present invention is particularly advantageous as it provides a device that prevents internal strain from occurring to the power cord of an RV, a boat, or other similar vehicle of the like. In addition, the device can be universally used with any power cord size, shape, and configuration. Further, the device secures a power cord in place during use. In this manner, the power cord strain relief device provides a solution to preventing power cord internal strain when used with RVs or other vehicles of the like.

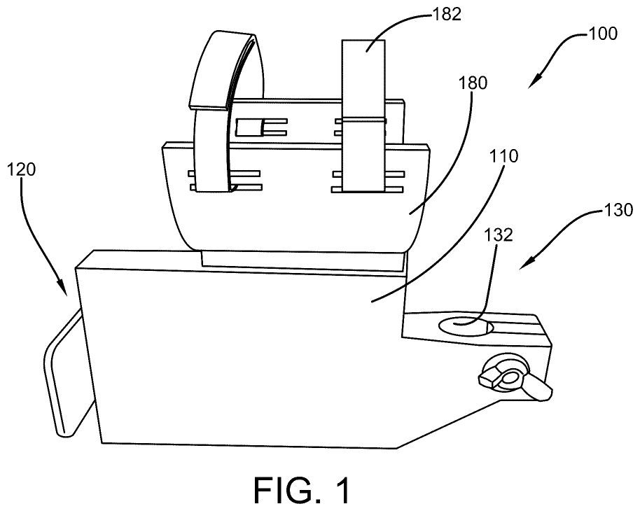

Referring initially to the drawings, FIG. 1 illustrates a side perspective view of one potential embodiment of a power cord strain relief device 100 of the present invention in accordance with the disclosed architecture. The device 100 is designed to reduce and/or remove strain from a power cable that may be connected to an RV, marine vehicle, or other vehicle of the like. The device 100 is comprised of a body 110, the body 110 comprised of a first end 120 and a second end 130. The body 110 may be made from any material such as but not limited to a UV-resistant plastic (to prevent sun damage), a corrosion-resistant metal (to prevent rust), etc.

The first end 120 of the body 110 is comprised of at least one member 121 that rests against the bumper 10 of an RV (or another surface of another vehicle). The member 121 may be any shape but is preferably rectangular. In one embodiment, the member 121 is comprised of an additional fastener 122 such as but not limited to a magnet or an adhesive in order to stick to the bumper. In a further embodiment, the member 121 may be in the form of a clip or a clamp that attaches to the bumper 10.

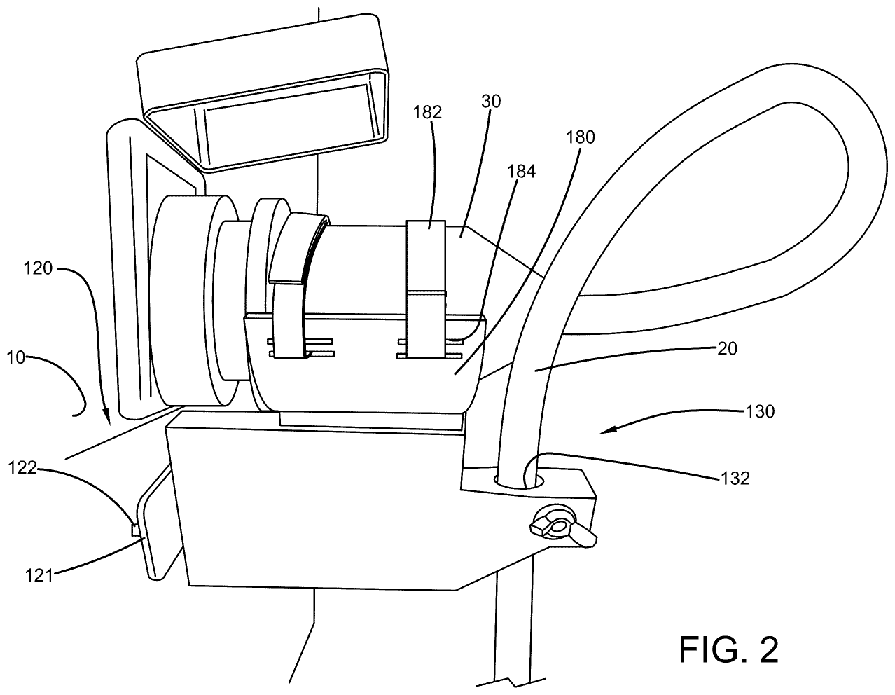

The second end 130 is comprised of at least one opening 132. In one embodiment, the opening 132 may be formed by a first half 140, a second half 150, and a connector 160. More specifically, the connector 160 is positioned between the halves 140,150. As a result, a power cord 20 can be placed between the halves 140,150, wherein the connector 160 can then be inserted between the halves 140,150 and wherein at least one fastener 170 can be placed through the halves 140,150 and connector 160 such that the opening 132 is formed and the cord 120 is secured within the same, as seen in FIG. 2. The fastener 170 may be any fastener type but is preferably a bolt and nut assembly and/or a bolt, nut, and washer assembly. As a result, the power cord 20 is secured to the device 100. It should be appreciated that the opening 132 may be formed by any structure of the body 110 that may be repositionable and/or removable in different embodiments, so long as the opening 132 allows a power cord 20 to be placed into and secured within the opening 132.

The device 100 is also comprised of a receiving area 180. The receiving area 180 receives a power cord head 30 of a power cord 30, as seen in FIG. 2. The receiving area 180 may be any shape such that it can securely receive a power cord head 30 but is preferably semi-circular such that a bottom half of the head 30 rests within and is supported by the receiving area 180. To further secure the power cord head 30 into the receiving area 180, the receiving area 180 may be comprised of at least one fastener 182. The fastener 182 may be but is not limited to a hook and loop strap, an elastic strap, a tie fastener, a clip fastener, a clamp fastener, etc. As a result, the power cord head 30 remains secured to the device 100 while the positioning of the power cord 20 in the opening 132 reduces or eliminates internal strain within the power cord 20. The fastener 182 may removably or fixedly attach to any portion of the receiving area 180.

It should be appreciated that any features of the device 100 such as but not limited to the receiving area 180, the opening 132, the halves 140,150, etc. may be sized and configured to receive any size, shape, and configuration of power cord.

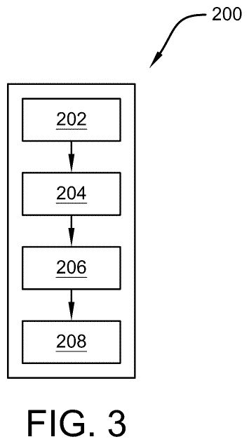

The present invention is also comprised of a method of using 200 the device 100, as seen in FIG. 3. First, a device 100 is provided comprised of a body 110 comprised of a second end 130 comprised of an opening 132 and a receiving area 180 comprised of a fastener 182 [Step 202]. Then, a power cord head 30 of a power cord 20 can be plugged into an RV or other vehicle [Step 204]. Next, the power cord 20 can be positioned within the opening 132 such that the cord 20 and/or cord head 30 does not experience external strain [Step 206]. Next, the power cord head 30 can be positioned within the receiving area 180 and secured within said area 180 via the fastener 182 [Step 208].

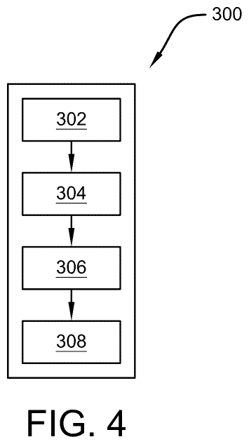

In a second method of using 300 the device 100, as seen in FIG. 4, a device 100 is first provided comprised of a body 110 comprised of a receiving area 180 comprised of a fastener 182, and a second end 130 comprised of an opening 132 formed by a first half 140, a second half 150, a connector 160, and a fastener 170 [Step 302]. Then, a power cord head 30 of a power cord 20 can be plugged into an RV or other vehicle [Step 304]. Next, the power cord 20 can be positioned within the opening 132 such that the cord 20 and/or cord head 30 does not experience external strain, wherein the cord 20 is secured within the opening 132 via placing the connector 160 between the first half 140 and second half 150 and placing the fastener 170 through all three components 140,150,160 [Step 306]. Next, the power cord head 30 can be positioned within the receiving area 180 and secured within said area 180 via the fastener 182 [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “power cord strain relief device” and “device” are interchangeable and refer to the power cord strain relief device 100 of the present invention.

Notwithstanding the forgoing, the power cord strain relief device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the power cord strain relief device 100 as shown in the FIGS. are for illustrative purposes only, and that many other sizes and shapes of the power cord strain relief device 100 are well within the scope of the present disclosure. Although the dimensions of the power cord strain relief device 100 are important design parameters for user convenience, the power cord strain relief device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A power cord strain relief device comprising:
a first fastener;
a second fastener; and
a body comprised of:
a first end comprised of a member;
a second end comprised of an opening formed by a first half, a second half, and a connector; and
a receiving area.

2. The power cord strain relief device of claim 1, wherein the first fastener is positioned through the first half, the second half, and the connector.

3. The power cord strain relief device of claim 2, wherein the first fastener is comprised of a bolt and nut assembly.

4. The power cord strain relief device of claim 1, wherein the second fastener is comprised of a strap.

5. The power cord strain relief device of claim 1, wherein the member is comprised of a rectangular shape.

6. The power cord strain relief device of claim 1, wherein the receiving area is positioned between the first end and the second end.

7. A power cord strain relief device comprising:
a first fastener;
a second fastener; and
a body comprised of:
a first end comprised of a member;
a second end comprised of a first opening formed by a first half, a second half, and
a connector; and
a semi-circular receiving area.

8. The power cord strain relief device of claim 7, wherein the body is comprised of a UV-resistant plastic.

9. The power cord strain relief device of claim 7, wherein the receiving area is comprised of a second opening.

10. The power cord strain relief device of claim 9, wherein the second opening receives the second fastener.

11. The power cord strain relief device of claim 10, wherein the second fastener is comprised of a strap.

12. The power cord strain relief device of claim 11, wherein the strap is comprised of a hook and loop strap or an elastic strap.

13. The power cord strain relief device of claim 7, wherein the second fastener is comprised of a clip or a clamp.

14. The power cord strain relief device of claim 13, wherein the second fastener connects to the semi-circular receiving area.

15. The power cord strain relief device of claim 7, wherein the connector is positioned between the first half and the second half.

16. The power cord strain relief device of claim 15, wherein the first fastener is positioned through the first half, the second half, and the connector.

17. The power cord strain relief device of claim 16, wherein the first fastener is comprised of a bolt.

18. A method of using a power cord strain relief device, the method comprising the following steps:
providing a power cord strain relief device comprised of a body comprised of a second end comprised of an opening, and a receiving area comprised of a fastener;
plugging a power cord head of a power cord into an RV or a vehicle;
positioning the power cord into the opening such that the power cord does not experience internal strain; and
positioning the power cord head within the receiving area and securing the power cord head within the receiving area via the fastener.

19. The method of using a power cord strain relief device of claim 18, wherein the fastener is comprised of a strap.

20. The method of using a power cord strain relief device of claim 18, wherein the receiving area 180 is comprised of a semi-circular receiving area.
